(19) United States
(12) Patent Application Publication
(10) Pub. No.: US 2004/0142688 A1
(43) Pub. Date: Jul. 22, 2004

(54) Method for optimising the access to an internet type network by means of a cellular radio-communication type network, corresponding system and device

(75) Inventor: Jean-Gabriel Remy, Paris (FR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Societe Francaise Du Radiotelephone, Paris La Defense (FR)

(21) Appl. No.: 10/704,292

(22) Filed: Nov. 7, 2003

(30) Foreign Application Priority Data
Nov. 7, 2002 (FR) FR 02 13974

(51) Int. Cl. H04Q 7/20

(52) U.S. Cl. 455/423; 455/428; 455/445

(57) ABSTRACT

The invention concerns a method for optimising the access to an Internet type network (130) by means of a cellular radio-communication network (109) presenting different types of interface that may be observed (100, 103, 105, 107, 1010, 131), the method comprising:

a data traffic generation step (401) between a terminal (100) belonging to the cellular network and at least one server (131, 132, 133) of the Internet type network.

a synchronous capture and time dating step for the first signalling information specific to the cellular network and second signalling Internet type information transiting by at least one interface of one of the types of interface that may be observed ; and

a centralisation step for the first and second time dated information.

The invention also concerns a corresponding system and device.

This invention concerns the field of cellular radio-communication networks, and more specifically the control and optimisation of communications between a cellular network and an Internet type server.

The purpose of this type of control is to optimise the operation of the cellular radio-communication network and to detect defects as quickly as possible. This control is also used to assess the quality of the service provided.

Before we present the known techniques of controlling networks, with their respective disadvantages, we shall provide a brief reminder of some of the structural characteristics of a cellular network.

Generally, a cellular radio-communication network is controlled by a base transceiver station, which provides an entry to the network for mobile stations from its cell so that it can receive and/or transmit calls. Each base station is in turn supervised by a base station controller, using the GSM standard.

Some mobile networks offer data transfer services. Thus, for example, the GPRS (General Packet Radio Service) standard is dedicated to such services. This standard is described by the ETSI (European Telecommunication Standard Institute), especially in the document entitled “Digital cellular telecommunications systems (Phase 2+); General Packet Radio Service (GPRS); Service Description; GSM 03 60 Version 7.4.1 Release 1988) under the ETSI reference EN 300 344 Version 7.4.1 (2000-09).

Thus a mobile terminal that is compatible with the GPRS standard can access Internet type servers. The mobile terminal is thus suited to emit data transfer requests to an Internet server and to receive the requested data from the server. The exchanges then take place on at least two networks using the corresponding protocol:

a GPRS type cellular network using a specific GPRS protocol; and

a fixed Internet type network using an IP (Internet Protocol) type protocol.

Traditionally, the following types of interface are distinguished, via which the data exchanged between a GPRS terminal and an Internet type server transits:

an Air interface, situated between the terminal and the base station (BTS) of the geographical cell in which the terminal is situated;

an Abis interface, each situated between the base station (BTS) and the corresponding base station controller (BSC);

a Gb interface between the BSC and a SGSN (Serving GPRS Support Node);

a Gn interface between the SGSN and a GGSN (Gateway GPRS Support Node);

a Gi interface between the GGSN and an Internet network to which the server belongs.

The first known network control technique consists of using “sentinels”, which is to say personnel covering a zone to be tested with measuring equipment called mobile trackers (generally these mobile trackers are specialised mobile telephones connected to computers to store the measurements taken). The measurements (field, B.E.R., etc.) are associated to the geographical position where they are taken by means of GPS (“Global positioning system” type locating emitters. It is thus possible to create cover maps indicating the problem zones for the Air interface.

This first known technique has many disadvantages. In particular, it only provides a limited amount of information as it is only used at the Air interface level, on the fixed radio downlink to the mobile. More especially, it does not permit information on the uplink (tracker mobile to the cellular network) to be obtained. In fact, this “sentinel” technique permits the quality of the network to be partially assessed from the client's point of view, and consequently only allows a partial vision of the network's operation.

Furthermore, the sending of information from the tracker mobile is long and complex. In fact, at present the data stored on each tracker mobile is copied onto floppy disks so that it can be centralised and processed globally. All of this implies long periods, as the measurement period is added to that of the data transfer via disks as well as the post-processing of the results.

Moreover, the tracker mobile—used in the first known technique are very expensive, and in fact they cost twenty times more than that of a traditional mobile station.

In addition, this technique only concerns the cellular network and is not adapted to the analysis of Internet type data.

A second known network control technique consists of using personnel to connect, according to the geographical zone to be examined, one or more protocol analysers on one or more network interfaces. Each protocol analyser allows the signal frames circulating on the interface monitored to be intercepted. After post-processing, the most interesting information on the operation of the network can be deducted, and in particular the behaviour of the network in terms of traffic, call failures or handovers.

This second known technique therefore consists of using monitoring at certain interfaces of the network. It also has disadvantages.

The second known technique requires a lot of qualified personnel in the field. In fact, at least one qualified person must be present on each measurement site to connect the protocol analyser correctly and to pilot it adequately to permit pertinent information to be obtained during the limited test period.

In addition, sending the information (from the protocol analysers in this case) is the same as for the first known technique, long and complex. In fact, at present the data stored on each protocol analyser is copied onto floppy disks so that it can be centralised and processed globally. All of this implies long periods, as the measurement period is added to that of the data transfer via disks as well as the post-processing of the results.

Finally, with the second known technique, the information obtained cannot be associated to any geographical information more precise than the cell itself. In other terms, it is impossible to localise precisely the segment of the cellular network tested by a protocol analyser. By segment of cellular network tested, we mean in this case the part of the network situated between the interface monitored (which is to say at the level where the protocol analyser is connected) and the mobile station(s) concerned (which is to say that or those whose protocol information transits on the interface monitored) . This lack of precise localisation of the segments analysed prevents a precise image of the exact operation in the field from being determined, and at the same time prevents a defect from being localised geographically and consequently from taking the necessary measures to correct a quality defect at the precise spot determined from these segments analysed.

There are also network control techniques based on means of the following type:

METRICA (registered trademark) which uses counters in BSC, SGSN or GGS type machines or

TEMS (registered trademark) mobile tracker made by ERICSSON (registered trademark) which captures the exchanges with the base stations of the mobile network.

Nevertheless, these techniques have the disadvantage of not permitting the detection of protocol anomalies.

In the state of the technique, also known is a patent document entitled “Control system and method of a cellular radio-communication network via a group of protocol analysers and mobile stations”, filed on Sep. 17^{th}, 1996 by CEGETEL Etudes et Gestion GIE, under the number FR 96 11531. This technique based on fixed recording means and time dating of signalling information transiting by at least one interface of type Abis, A, CCITT n° 7 telephone and MAP, and fixed means for centralising the information recorded permits the information to be collated on the state of the operation of the network and to obtain a precise localisation of the segments of the network analysed.

Nevertheless, this technique has the disadvantage of not permitting the identification of problems precisely localised and specific to the access to an Internet type network by terminals belonging to a cellular telecommunication network.

This technique also has the disadvantage of not permitting the optimisation of the cellular network parameters in view of an access to an Internet type network.

The specific aim of the invention is to eliminate these disadvantages of the state of the technique.

More precisely, one of the aims of this invention is to provide a system and a control method for a cellular radio-communication network that can be used with a high degree of precision and very significantly improved efficiency, in spite of the fact that it is simpler and less expensive than the known solutions (in particular by reducing the personnel and by not requiring mobile trackers), whilst permitting a maximum amount of information to be gathered on the state of the network's operation.

An additional aim of the invention is to provide such systems and methods which permit the access to an Internet network by a cellular network terminal to be optimised and in particular to offer an end to end quality of service (and not just at the front server level).

Another aim of the invention is to optimise the data download times to a cellular network terminal from an Internet type site.

Another aim of the invention is to reduce the leak of data transiting via a cellular network terminal and an Internet type site, to correct the hardware defects present on the route of the data between a cellular network terminal and an Internet network and/or to optimise the parameters of this hardware.

Moreover, the aim of the invention is to optimise the different Internet and cellular network parameters to improve globally the information exchanges between the two networks.

Furthermore, the aim of the invention is to detect protocol anomalies and/or to check the correct linking of messages exchanged on the cellular network and corresponding to accesses to an Internet server.

These aims, as well as others which will subsequently become clearer, are achieved by the invention, by means of an optimisation method for access to an Internet type network via a cellular radio-communication network with different types of interfaces that may be observed, the method comprising a data traffic generation step between a terminal belonging to the cellular network and at least one server of an Internet type network, that is remarkable in that it comprises, among others:

a synchronous capture and time dating step for the first signalling information specific to the cellular network and second signalling Internet type information transiting by at least one interface of one of the types of interface that may be observed ; and

a centralisation step for the first and second time dated information.

The signalling information specific to the cellular network is in particular update information from the specific elements of the cellular network (for example of the type mobile station, base station, base station controller, etc.). This information concerns, for example, the routing of packets inside the cellular network, disassociating or assembling of packets for transmission on the cellular network compatible with the communication protocols used, the identification of such corresponding packets or buckets inside of the cellular network, etc.

The Internet type signalling information is, for example, the IP addresses of the source and destination of the packets, or the identification of the packets specific to the Internet type network.

An interface that may be observed is, in particular, an interface between two cellular network or Internet elements, on which a capture probe may be placed to capture and time date the traffic information transiting via this interface. The time dated Internet type information is also collected by the remote Internet server addressed by the terminal or equipment generating the data traffic (e.g. micro-computer) as well as by the terminal or this equipment itself (the server, the terminal and/or this equipment being considered, according to the invention, as interfaces that may be observed).

A data capture step at an interface is supposed to be synchronous with a corresponding data capture step at another interface due to the precise time dating. This way, the precise time dating permits a rigorous and efficient comparison and analysis of the different synchronous information (first and second) that is captured and centralised, and with a margin or error that is zero or negligible.

The centralisation step permits the information captured and time dated to be assembled at a single point, for analysis in real time or later. In this way, the analysis can be carried out globally taking into, account the information from a known source and dated precisely.

According to one specific characteristic, the method is remarkable in that the capture and time dating step is carried out by at least one probe and/or a data traffic generator associated to the terminal and in that the centralisation step comprises a transmission step of the first and second information time dated at the first analysis means of the first and second captured information.

In this way, the first analysis means have a global and precise vision of the traffic between the cellular and Internet type networks and can also use optimally the information specific to the cellular network and the Internet type information.

To carry out the control of a network, an overall view is necessary. In fact, only an overall view can permit the lacks and defects of a network to be highlighted at a given moment, and to diagnose the causes. In this case, the global analysis takes simultaneously into account the content of the packets transferred, the Internet and the cellular network signalling, the precise time date for the majority of the transit points remarkable in that a cellular network terminal and an Internet server permits precise and rapid diagnosis. In this way, targeted corrections can be rapidly implemented in order to reduce as far as possible the sources of user discontent by considerably improving the quality of service in the network.

According to one specific characteristic, the method is remarkable in that the first analysis means use a step to determine the time passed (RTT) between:

the emission of a request transmitted by the terminal to an Internet type server; and

the reception, by the terminal, of a response to the request.

In this way, the analysis means permit the network elements which significantly increase the RTT to be identified, and/or the network elements which, on the contrary, have very low or negligible transit times.

According to one specific characteristic, the method is remarkable in that the first analysis means use a step to compare the data associated to the first and second information, in order to identify the routing of a request packet emitted by the terminal to an Internet type server and/or a response packet corresponding to the request packet and emitted by the server to the terminal.

According to one specific characteristic, the method is remarkable in that it comprises a step for determining the data leak in the request and/or response packets.

In this way, the first analysis means permit the loss of entire or parts of packets to be identified. They can also calculate the leak rate of binary data, parts of packets (in particular buckets and/or entire packets for each of the elements of the cellular network or part of them).

According to one specific characteristic, the method is remarkable in that the first analysis means comprise a step to determine at least an anomaly in the exchange of data packets between the terminal and an Internet type server.

In this way, the method indicates which elements of the cellular or Internet type network are defective and need to be repaired, and/or have their parameters optimised. By way of illustration, if packets are lost, the parameters defining the sizes of the input or output buffer memories of the various network elements concerned may be redefined and optimised.

According to one specific characteristic, the method is remarkable in that the first information comprises, among others, analysis information generated by second analysis means associated to the terminal.

In this way, the first information comprises not only information, which transits via at least one interface that may be observed, but also analysis information generated, for example, by a terminal control device. This permits the application of the invention to be simplified, as part of the analysis is processed locally and dedicated tools permitting an elementary analysis of the traffic (e.g. RTT times) are available.

According to one specific characteristic, the method is remarkable in that the second information comprises, among others, analysis information generated by third analysis means associated to the server.

In this way, the second information also comprises analysis information generated, for example, by software tools used in one or more servers from the servers accessed by the terminal. This also permits the application of the invention to be simplified, as part of the analysis is processed in one or more of the servers and that dedicated tools permitting such an analysis of the traffic (e.g. IP data) exist and are on sale.

According to one specific characteristic, the method is remarkable in that the second signalling information belongs to the group comprising:

IP (Internet Protocol) type signalling information;

TCP (Transmission Control Protocol type signalling information;

UDP (User Datagram Protocol) type signalling information;

Hypertext type signalling information;

FTP (File Transfer protocol) type signalling information.

According to one specific characteristic, the method is remarkable in that the cellular network belongs to the group comprising:

the GSM (Global System for Mobile Communication) networks;

the GPRS (General Packet Radio Service) network;

the third generation mobile networks.

According to one specific characteristic, the method is remarkable in that it comprises, among others, a defect search step on at least one element of the cellular network positioned between the terminal and the Internet type network.

Thanks to the global analysis of the traffic between the terminal and an Internet server, anomalies (e.g. lost packets, transit times which are too long, etc.) can be identified and consequently permit one or more defective elements to be localised in the data traffic transmission and/or signalling chain.

According to one specific characteristic, the method is remarkable in that it comprises, among others, a step for optimising the parameters of at least one element of the cellular network positioned between the terminal and the Internet type network.

The identification of the anomalies also permits the network element(s) whose parameters are not optimised to be localised, an anomaly which corresponds in general to either a defective element or one or more specific parameters that are not optimised (e.g. as previously indicated, a loss of packets may be linked to incorrect parameter settings of the size of the buffer memories). The method can thus advantageously be used both in a set-up phase for a network element by a manufacturer (to overcome design or manufacturing problems) and in an operational and/or optimisation phase of the network by an operator.

The invention concerns, among others, a system for optimising the access to an Internet type network via a cellular radio-communication network possessing different types of interface that may be observed, the system comprising data traffic generation means between a terminal belonging to the cellular network and at least one server of the Internet type network. According to the invention, the system comprises, among others:

means for synchronous capture and time dating of the first signalling information specific to the cellular network and second Internet type signalling information transiting by at least one interface of one of the types of interface that may be observed ; and

means for centralising the first and second time dated information.

The invention also concerns a device for optimising the access to an Internet type network via a cellular radio-communication network possessing different types of interface that may be observed, the cellular network comprising data traffic generation means between a terminal belonging to the cellular network and at least one server of the Internet type network. The device comprises, among others, means for analysing first signalling information specific to the cellular network and second Internet type signalling information transiting by at least one interface of the types of interface that may be observed, the first and second information captured being time dated.

The advantages of the system and the optimisation device are the same as those of the method, they are not described in more details.

Other characteristics and advantages of the invention will become clearer upon reading the following description of a preferred embodiment, given purely by way of example and in no way restrictive, and the appended diagrams, among which:

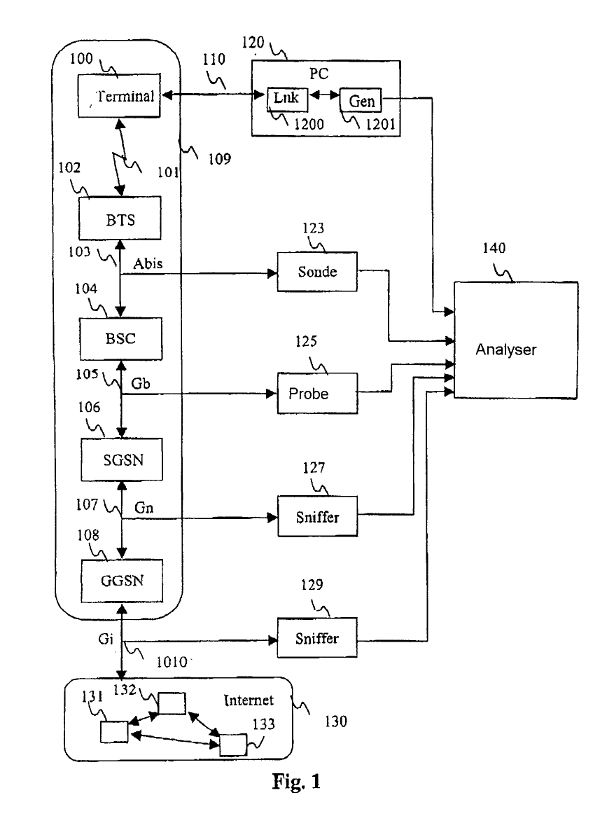

FIG. 1 shows a block diagram of the cellular communication network, according to a specific embodiment of the invention;

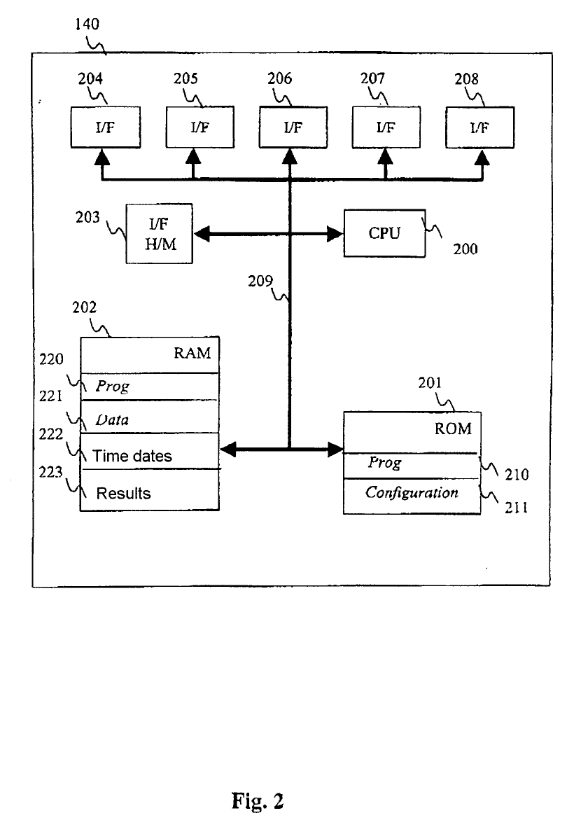

FIG. 2 illustrates diagrammatically a network analyser of FIG. 1;

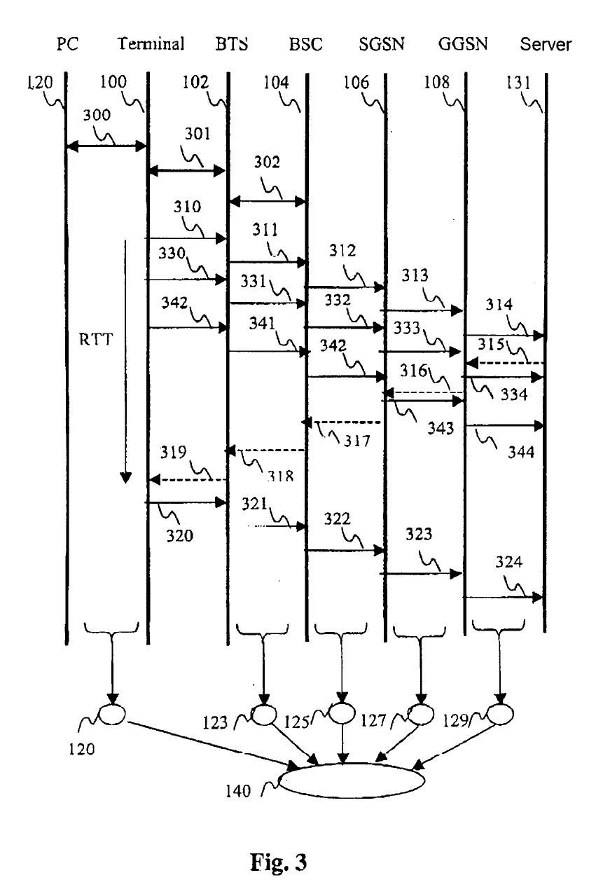

FIG. 3 shows a communication protocol between the various network elements of FIG. 1;

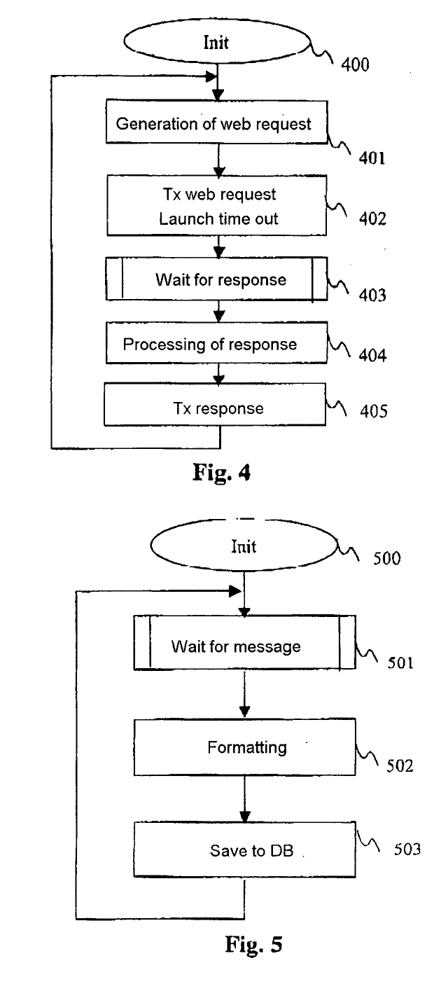

FIG. 4 describes an algorithm used by a computer connected to a terminal of FIG. 1; and

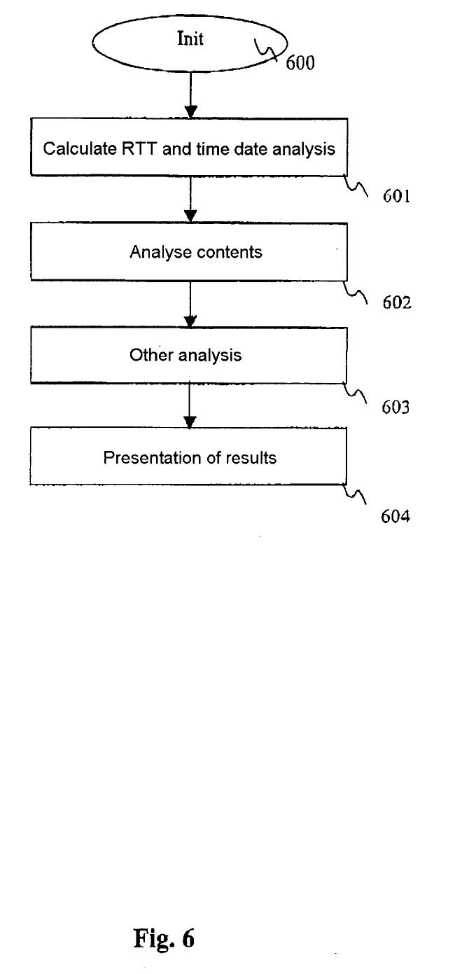

FIGS. 5 and 6 illustrate the algorithms used by the analyser of FIG. 2.

The general principle of the invention is based on the generation of requests emitted by a dedicated terminal on a cellular network destined for an Internet network and preferably up to a specific server dedicated to observation, the data exchanged between the dedicated terminal and the cellular network being recorded and time dated at different points of the route of the data and transmitted to a central analysis device.

It is therefore especially possible to estimate the transit times between the specific points on the route, which allows transit times that are too long to be identified, which cause Round Trip Times being exceeded, which is the time required for a return trip between a terminal on the cellular network and an Internet server. Generally, the RTT must be less than or equal to three seconds. When the RTT is too long, specific methods of the cellular network and the Internet network require the requests or data to be retransmitted, which disrupts the network, slows down transfers and can cause breaks in the exchanges.

For the exchanges between the different points of the cellular and Internet type networks, the data is sectioned into blocks and encapsulated in the Internet packets. The Internet packets themselves may be sectioned into smaller blocks called buckets. Losses of buckets may occur at different points of transit (especially in the fixed part of the cellular network). If the bucket leak rate is too high, the exchanges between a terminal and a server are difficult. By correlating the information at the different points of transit, according to the invention, it is possible to identify the defective points.

In this way, for example, to optimise the RTT's and/or reduce the data packet leak rate, the invention makes possible the precise identification of the origin of the problems encountered and consequently the correction of their causes, in particular by modifying the parameters of the defective points (e.g. the sizes of the reception and emission buffer memories) and/or by highlighting or correcting the design and/or manufacturing errors of the equipment concerned.

In relation with FIG. 1, we present a block diagram of a cellular communication network, according to a specific embodiment of the invention.

The network uses:

a GPRS type cellular sub-network 109;

an Internet sub-network 130;

The GPRS 109 sub-network comprises:

a terminal 100;

a BTS base station 102;

a BSC base station controller 104;

an SGSN node 106; and

a GGSN node 108.

The terminal 100 is connected to a micro-computer 120 via a connection 110 and to the BTS station 102 via a radio connection 101. The computer 120 comprises a COMMVIEW (registered trademark) type interface 1200 (back up software of the packets received) which acts as the interface between the terminal 100 via a wire connection 110 and a FTP (File Transfer Protocol) and/or Internet type request generator 1201.

The BTS station 102 is connected to the BSC controller 104 via an Abis type standardised interface 103. A probe 123 corresponding to the K1205 model (registered trademark) manufactured by TEKTRONIX (registered trademark) allows the different frames (especially request or data) which transit via the Abis standardised interface 103 to be acquired.

The BSC controller 104 is connected to the SGSN node 106 via a Gb type standardised interface 105. A probe 105 corresponding to the K12 model (registered trademark) manufactured by TEKTRONIX (registered trademark) permits the various frames which transit via the Gb interface 105 to be acquired. Furthermore, the BSC controller 104 is associated to PCU type means made by NOKIA (registered trademark) or MFS means made by ALCATEL (registered trademark).

The SGSN node 106 is connected to the GGSN node 108 via a Gn standardised interface 107. The GGSN node 108 is connected to the Internet network 130 via a Gi type standardised interface 1010. Two probes 127 and 129 of the Sniffer Pro type (registered trademark) made by NETWORK ASSOCIATES (registered trademark) scan the different frames respectively transiting via the Gn 107 and Gi 1010 interfaces.

Each of the probes 123, 125, 127 and 129 and the computer 120 are connected to analysis means 140 via specific connections.

The Internet network 130 comprises:

A server 131, for example of the APACHE type (registered brand) comprising an IP packet analysis, and which is dedicated to analysis; and

any web or FTP type servers 132 and 133 accessible from the GGSN node 108.

It is supposed that the servers 131 to 133 function correctly and respond rapidly to requests with a sufficient rate.

The characteristics of the server 131 are optimised and are supposed to be known, which permits a fine analysis of the exchanges between the terminal 100 and the server 131 by the analyser 140. Moreover, the server 131 is adapted to transfer its own IP packet analysis results to the analyser 140 via the probe 129.

According to one embodiment of the invention, for the purposes of analysis of the exchanges of packets on the networks 109 and 130, the terminal 100 accesses one or more servers of the network 130 not dedicated to analysis. It is supposed that these servers operate correctly and that their characteristics (in particular the response time to a request and flow) are preferably known to the analyser 140. In this way, as this embodiment does not require a server dedicated to analysis, this permits simplification of the installation and provides very accurate and realistic analysis results.

The BTS station 102, the BSC controller 104, the SGSN 106 and GGSN 108 nodes, the network 120 and the connections between these elements are part of any known network and are not the subject, according to the invention, of any particular adaptations.

FIG. 2 is a diagrammatic illustration of an analysis device 140 such as that mentioned in FIG. 1.

The device 140 comprises the following elements, connected to one another by a data and address bus 209:

a processor 200;

a random access memory 202;

a non-volatile memory 201;

a man machine interface 203 comprising a screen and a keyboard; and

five interfaces 204 to 208 each permitting a connection with one of the probes 123, 125, 127 and 129 or the computer 120.

Each of the elements illustrated in FIG. 2 is familiar to those skilled in the art. These common elements are not described here.

It can be observed that the word “register” used in all of the description designates in each of the memories mentioned, both a small capacity memory zone (a few binary data) and a large capacity memory zone (permitting an entire programme or all of the data between the terminal 100 and the Internet network 130 to be stored).

The non-volatile memory 201 keeps in registers, which for commodity have the same names as the data they store:

the processor 200 operating programme in a register “Prog” 210, and

the configuration of the analysed GPRS network 109, the probes 123, 125, 127 and 129 and of the computer 120 in a register “Configuration” 211.

The algorithms using the steps of the methods described hereunder, especially with respect to the FIGS. 5 and 6, are stored in the memory 201 associated to the device 140 using the steps of these algorithms. When the power is switched on, the processor 200 loads and executes the instructions of these algorithms.

The random access memory 202 comprises in particular:

the “Prog” 220 operating programme of the processor 200 loaded when the device 140 is powered up;

the data captured by the probes 123, 125, 127 and 129 as well as the data emitted or received by the computer 120, in a register “Data” 221;

the time dates corresponding to the data 221 in a register “Time dates” 22; and

the analysis results in a register “Results” 223.

In one embodiment not shown, the data 221, 222 and 223 is also stored in the memory 201 (for example a hard disk).

The random access memory 202 stores data, variables and intermediate processing results.

With respect to FIG. 3, we present a general block diagram of the communication protocol using the various elements illustrated with respect to FIG. 1, and in particular the computer 120, the terminal 100, the BTS station 102, the BSC controller 104, the SGSN 106 and GGSN 108 nodes as well as, for example, the server 131 of the Internet network 130.

After generating a HTTP hypertext access or FTP transfer request, destined for the Internet network server 130, and whose characteristics are known to the analyser 140, the computer 120 emits this request to the terminal 100 during a step 300.

Then, during the steps 301 and 302, communication is established between the terminal 100 and the BTS station 102, on the one hand and between the BTS station 102 and the BSC controller 104 on the other hand, according to a GPRS type protocol.

Subsequently, during a step 310, the terminal 100 sections the request previously generated by the computer 120 into several packets P1, P2 and P3, and emits the first packet P1 to the BTS station 102. Then during a step 311, the packet P1 received by the BTS station 102 is re-emitted after formatting according to the GPRS protocol to the BSC controller 104. Then the packet P1 is successively retransmitted to the SGSN 106 and GGSN 108 nodes and the Internet server 131 after formatting and possibly sectioning into smaller packets each corresponding to a bucket, respectively during the steps 312, 313 and 314.

In parallel, the second packet P2 is successively transmitted to the BTS station 102, to the controller 1004, to the SGSN 106 and GGSN 108 nodes and the Internet server 131 after formatting and possibly sectioning into smaller packets each corresponding to a bucket, respectively during the steps 330 to 334.

Similarly, after the transmission of the second packet P2, each of the elements 100, 102, 104, 106 and 108 formats after possible sectioning and transmits the third packet P3 to the following element of the transmission chain between the terminal 100 and the server 131.

Following reception of the frame(s) corresponding to the packet P1 during step 314, the Internet server 131 transmits a response R1 to the GGSN node 108 during a step 315, using an IP type protocol destined for the terminal 100. In this way, this response is formatted to the GPRS protocol successively by the GGSN 108 and SSGN 106 nodes, the BSC controller 104 and the BTS station 102, then transmitted to the following node until it reaches the terminal 100, respectively during the steps 316 to 319.

Upon reception of the response R1 during step 319, the terminal 100 prepares a corresponding acknowledgment Ack1 and transmits it to the BTS station 102 during a step 320. This acknowledgment Ack1 destined for the server which transmitted the response R1 is successively transferred to the BSC controller 104, to the SGSN 106 and GGSN 108 nodes, and to the server 131 respectively during the steps 321 to 324.

Furthermore, the content of each of the time dated exchanges between the terminal 100 and the computer 120 is transmitted to the analysis device 140 by the computer 120.

Similarly, each of the packets especially of the request, response and acknowledgment type, exchanged by the BTS station 102, the controller BSC 104, the SGSN 106 and GGSN 108 nodes and the Internet network 130 are captured and time dated by one of the probes 123, 125, 127 and 129. After each capture, the corresponding probe transmits the time dated content of this capture to the device 140.

The device 140 memorises the time dated content, the corresponding time date and the origin of the message (terminal 120, probes 123, 125, 127 or 129).

According to one embodiment not shown, the server 131 analyses locally the content of the IP packets exchanged and transmits the corresponding results with the time date to the analyser 140 via the probe 129. The analyser 140 then memorises these time dated results and their origin (the server 131) for a global analysis later.

The RTT corresponding to the time difference between the emission of the first request P1 by the terminal 100 during the step 310 and the reception of the corresponding response A1 during the step 319 has been represented with respect to FIG. 3. The terminal 100 can accept abnormal RTT's (especially those significantly more than 3 seconds) in order to permit the complete execution of a request and response method for global analysis by the device 140. In this way, if the RTT exceeds a pre-established maximum threshold, the device 140 can detect an abnormal length of the RTT and identify, based on all of the time dates of the steps 310 to 314 and 315 to 319, the sources of time loss (for example due to a processing time by an element of the GPRS network that is too long or retransmissions of packets received incorrectly) which have caused the RTT to be too long.

Furthermore, the device 140 can compare the content of the packets captured and in particular the packets received and emitted by the BSC controller 104 or a SGSN 106 or GGSN 108 node to identify any possible losses of packets, if in particular the leak rate is too high.

According to one embodiment of the invention, the server 131 dedicated to the application of the invention and comprising means for analysing IP packets transmits, via the probe 129, its analysis results to the analyser 140, which is adapted to exploit them.

FIG. 4 describes an algorithm used by the computer 120 connected to the terminal 100.

This algorithm permits in particular the transmission of web or FTP requests and the reception of the associated results.

In this way, during a first step 400, the parameters and variables used according to the algorithm are initialised. In particular, a list of addresses of files belonging to Internet network 130 servers that can be downloaded and/or a list of addresses of web pages of network 130 servers are updated and memorised.

Then, during a step 401, the generator 1201 generates one or more file transfer type requests according to an FTP or web page protocol depending on the addresses memorised during the step 400.

Then, during a step 402, the request(s) previously generated and destined for one or more of any of the servers of the Internet network 130 are transmitted via the interface 1200:

on the one hand, to the terminal 100 which formats them for emission to the server(s) addressed via the GPRS network 109;

and, on the other hand, to the analysis device 140 in the form of a message comprising a request identifier and the content of the request(s).

In parallel, the generator 1201 launches a time-out associated to each request, the value of which is significantly greater than that of the RTT normally expected as part of the correct operation of the network (for example three seconds). A time out will be, for example, to one hundred and twenty seconds.

Then, during a step 403, the generator 1201 waits for:

each packet contained in the GPRS data frames (in particular response to web or FTP requests, acknowledgments, etc.) and received by the terminal 100;

for the end of a time-out launched during the step 402 and associated to a request to which no response has been received before the end of the time-out.

During the step 404, the result obtained (either a response or an anomaly, for example the end of a time-out) is then processed a first time by the COMMVIEW (registered trademark) type interface 1200, which in particular counts the frames received, the binary flow in reception and emission and analyses the content if a response has been obtained.

The interface 1200 then transmits to the device 140, during a step 405, a message which comprises in particular:

the identifier of the request associated to the response or the end of the time-out;

the nature of the result (response or end of the time-out);

the binary flows in reception or emission;

its content if it is a response;

the elements issued from the processing of the step 404; and

the nature of the protocol.

The step 401 is then repeated.

FIGS. 5 and 6 illustrate algorithms used by the analysis device 140. More specifically, FIG. 5 presents a first real time processing algorithm for the data communicated by the computer 120 and the probes 123, 125, 127 and 129. FIG. 6 describes a delayed analysis algorithm of the data received.

In this way, according to the algorithm of FIG. 5, during a first step 500, parameters and variables used according to the algorithm are initialised. The configuration of the GPRS network 109 and the corresponding probes is memorised in particular.

Then, during a step 501, the device 140 waits and receives messages transmitted by the compute 120 or the probes 123, 125, 127 and 129.

Then, during a step 502, the time dated data received is formatted.

Then the time date data is stored in a data base during a step 503.

The step 501 is then repeated.

The algorithm of FIG. 6 has to determine the elements of service quality and carries out the processing in delayed time which starts by a step 600 where the parameters are initialised and the variables used (in particular the network configuration and the characteristics of the servers 131 to 133 that may receive requests generated by the compute 120).

Then, during a step 601, the device 140 reads the data stored in the data base during the step 503 and identifies the result associated to each request (response received or end of the time out) as well as the various corresponding frames (response, request and possibly acknowledgment) that are transmitted to it by the computer 120 or the probes 123, 125, 127 and 129. For each request, the device 140 calculates from the time dates corresponding to the frames identified:

the global RTT (difference between the time dates of the request and the response transmitted by the computer 120 or the maximum RTT if no response is received before the end of the time out launched during the step 402); and

the transit time in the various elements of the GPRS network 109 based on the time dates of the frames corresponding to the interfaces adjacent to the element in question (e.g. the Gb 105 and Gn 107 interfaces for the SGSN 107 node).

Then, the device 140 displays on the screen 203 for each request the RTT and the different transit times calculated. According to one embodiment, only the times corresponding to an RTT and/or a transit time exceeding a predetermined threshold or dynamically updated by the user or automatically by the device 140 are presented on the screen.

According to another embodiment, each network element for which a transit time has exceeded a transit time threshold associated to the network element or to its type, possibly coupled to an RTT that is too long (which is to say that exceeds an RTT threshold) is identified and a corresponding anomaly indication is presented to the user. Preferably, an indication of the optimisation of the parameters is also presented to the user in the case of an anomaly being identified.

The device 140 calculates and also displays fine statistics (mean values, standard deviations, etc.) associated to the RTT's and to the transit times in each of the points of transit of the GPRS network 109.

In this way, the user of the device 140 can easily identify and determine if the RTT's and the transit times in the BTS station 102, the BSC controller 104 or the SGSN 106 and the GGSN 108 nodes are too long and are likely to cause disruptions in the data exchanges between a GPRS terminal and an Internet server. It may be noted that the servers that may receive requests generated by the computer 120 are supposed to operate correctly (the server must not be a source of blockage or excessive slowing down of the exchanges) and to respond rapidly to requests and with a sufficient flow.

Then, during a step 602, for each request, response and acknowledgment type entity exchanged between the Internet network 130 and the terminal 100, the device 140 identifies the different corresponding frames stored in the data base. Then, for each point on the route (BTS station 102, BSC controller 104, SGSN 106 and GGSN 108 nodes) and each request, the device 140 compares the input frame(s) identified corresponding to the output frame(s) identified by cross correlation.

The device 140 thus identifies any possible losses of packets on the data route.

Furthermore, the BSC controller 104 and the SGSN 106 and GGSN 108 nodes may section the input frames that are too big into smaller frames (or buckets) and/or concatenate several frames into a single larger frame. Bucket losses may then occur. A bucket leak rate that is too high is damaging to the correct operation of the network. By comparing and correlating the inputs and outputs of a particular point of the network, the device 140 identifies the bucket losses and determines bucket leak rate.

The device 140 then displays the bucket and more generally packet leak rate values, which permits the user to determine the defective points of the GPRS 109 network. The defective points may then be identified in order to permit, if applicable, their design and/or parameter (e.g. the size or number of input or output memories) defects to be corrected or their configuration updated.

According to one embodiment of the invention, the device 140 displays an identification of the defective point(s) as well as the origin of the defect (e.g. abnormal packet or bucket leak rate) and, preferably, propose an optimisation of the parameters allowing these losses to be remedied (e.g. by increasing the size of the input or output buffer memories of the corresponding network element).

Then during a step 603, the device carries out complementary analyses, in particular the percentage of packet retransmission, the locating of defects, the allocation of resources according to the load on the network, etc.

Then, during a final step 604, the global results are presented to the user.

According to one embodiment, the analysis results are memorised and/or printed out.

Of course, the invention is not restricted to the examples mentioned above.

In particular, those skilled in the art will be able to add all variations in the definition of the cellular networks (e.g. GSM, GPRS, UMTS type, etc.) and Internet networks (FTP, HTTP access, etc).

It can be noted that the Internet protocol is not restricted to TCP/IP but extends to all types of compatible protocols and in particular a UDP type protocol.

The invention is not restricted to the GPRS nodes described but also includes all cellular network elements adapted to transmit and/or receive frames encapsulating Internet type data (especially requests, responses acknowledgments, etc.) that may or may not modify the content of the frames exchanged.

Any variation may also be made to the nature of the probes, allowing data to be captured on cellular and/or Internet networks, the data may be time dated with precision and thus follow the routing of the data.

The generation of traffic data according to the invention is not restricted to the data generated by a computer either, but can also include data generated using any technique. The data generation device may, for example, be incorporated into the analysis device.

Those skilled in the art may also make any variation to the analysis of the data captured, especially as concerns the depth of the analysis (amount of data captured, network elements tested, etc.), the type of analysis carried out (especially with or without the calculation of transit times, RTT's, packet leak rates, problem location, etc.), the presentation of the results, etc.

It can be noted that the invention is not restricted to a purely hardware implantation but may also be used in the form of a series of instructions in a software programme or any form combining part software and part hardware. In the event of the invention being implanted partially or totally in software form, the corresponding instruction sequence may be stored in a removable means of storage (e.g. a floppy disk, a CD ROM or a DVD ROM, etc.) or not, this means of storage being capable of being read partially or totally by a computer or a micro-processor.

1. Method for optimising access to an Internet type network (130) by means of a cellular radio-communication network (109) presenting different types of interfaces that may be observed (100, 103, 105, 107, 1010, 131), the said method comprising a data traffic generation step (401) between a terminal (100) that is part of the said cellular network and at least one server (131, 132, 133) of the said Internet type network, characterised in that it comprises, among others:
a step of synchronous capture and time dating of first signalling information specific to the said cellular network and second Internet type signalling information transiting by at least one interface of one of the said interfaces that may be observed and
a step for centralising the said first and second time dated information.
the said step of capture and time dating being applied by at least one probe (123, 125, 127, 129) and/or a data traffic generator (120) associated to the said terminal and the said centralisation step comprising a step for the transmission of the said first and second time dated information to first analysis means (140) of the said first and second captured information, and
the said first analysis means use a step (601) for determining the time passed (RTT) between:
the emission of a request transmitted by the said terminal to a server of the said Internet type network; and
the reception, by the said terminal, of a response to the said request.

2. Method of claim 1, characterised in that the said first analysis means use a step to compare the data associated to the said first and second information so as to identify the route of a request packet emitted by the said terminal to a server of the said Internet type network and/or a response packet corresponding to the said request packet and emitted by the said server to the said terminal.

3. Method of claim 2, characterised in that it comprises a step (602) for determining the data loss in the said request and/or response packets.

4. Method of any of claims 1 to 3, characterised in that the said first analysis means use a step to determine at least one anomaly in the data packet exchange between the said terminal and the server of the said Internet type network.

5. Method of any of claims 1 to 4, characterised in that the said first information comprises, among others, analysis information generated by second analysis means (120) associated to the said terminal.

6. Method of any of claims 1 to 5, characterised in that the said second information comprises, among others, analysis information generated by third analysis means (131) associated to the said server.

7. Method of any of claims 1 to 6, characterised in that the said second signalling information belongs to a group comprising:
the IP (Internet protocol) type signalling information;
the TCP (Transmission Control Protocol) type signalling information;
the UDP (User Database protocol) type signalling information;
the Hypertext type signalling information;
the FTP (File Transfer Protocol) type signalling information.

8. Method of any of claims 1 to 7, characterised in that the said cellular network belongs to a group comprising:
the GSM (Global System for Mobile Communication) networks;
the GPRS (General packet Radio Service)networks;
the third generation mobile networks.

9. Method of any of claims 1 to 8, characterised in that it comprises, among others, a defect search step on at least one element of the said cellular network positioned between the said terminal and the said Internet type network.

10. Method of any of claims 1 to 9, characterised in that it comprises, among others, a step for optimising the parameter settings of at least one element of the said cellular network positioned between the said terminal and the said Internet type network.

11. System for optimising access to an Internet type network (130) by means of a cellular radio-communication network (109) presenting different types of interfaces that may be observed (100, 103, 105, 107, 1010, 131), the said system comprising data traffic generation means (401) between a terminal (100) that is part of the said cellular network and at least one server (131, 132, 133) of the said Internet type network, characterised in that it comprises, among others:
means of synchronous capture and time dating of first signalling information specific to the said cellular network and second Internet type signalling information transiting by at least one interface of one of the said interfaces that may be observed and
means for centralising the said first and second time dated information.
the said means of capture and time dating being applied by at least one probe (123, 125, 127, 129) and/or a data traffic generator (120) associated to the said terminal and the said centralisation means comprising means for the transmission of the said first and second time dated information to first analysis means (140) of the said first and second captured information, and
the said first analysis means use means to determine the time passed (RTT) between:
the emission of a request transmitted by the said terminal to a server of the said Internet type network; and
the reception, by the said terminal, of a response to the said request.

12. Device (140) for optimising access to an Internet type network (130) by means of a cellular radio-communication network (109) presenting different types of interfaces that may be observed (100, 103, 105, 107, 1010, 131), the said cellular network comprising data traffic generation means between a terminal that is part of the said cellular network and at least one server of the said Internet type network, characterised in that it comprises, among others, means of analysis of the first signalling information specific to the said cellular network and second Internet type signalling information transiting by at least one interface of one of the said interfaces that may be observed and second Internet type signalling information transiting by at least one interface of one of the said interfaces that may be observed, the said first and second captured information being time dated.
